(19) United States
(12) Patent Application Publication
(10) Pub. No.: US 2023/0311450 A1
(43) Pub. Date: Oct. 5, 2023

(54) TRIM ELEMENT COMPRISING A DISCRETE HEATING ELEMENT MADE OF CARBON MATERIAL

(71) Applicant: FAURECIA INTERIEUR INDUSTRIE, Nanterre (FR)

(72) Inventor: Xavier TONEU, GANDIA (ES)

(21) Appl. No.: 18/194,995

(22) Filed: Apr. 3, 2023

(30) Foreign Application Priority Data
Apr. 5, 2022 (FR) FR 22 03086

(51) Int. Cl. B32B 9/00; B60R 13/02; B32B 5/02; B32B 27/32

(52) U.S. Cl. CPC B32B 9/00; B60R 13/02; B32B 5/022; B32B 27/32; B60R 2013/0287; B32B 2451/00; B32B 2307/302; B32B 2260/021; B32B 2260/046

(57) ABSTRACT

The vehicle trim element (1) comprises at least one support layer (2), comprising an inner face (6) and an outer face (8), and at least one heating element (4) extending over a part of the inner face (6) or over a part of the outer face (8) of the support layer (2). The heating element (4) comprises at least one discrete continuous carbon element (10) consisting of a carbon material extending continuously in an uninterrupted way from a first edge (12) to a second edge (14), and a connecting device electrically connected with the carbon element (10), said connecting device being suitable for being electrically connected to a source of current.

### TECHNICAL FIELD

The present invention relates to a vehicle trim element, of the type comprising at least one support layer, comprising an inner face and an outer face, and at least one heating element extending over a part of the inner face or over a part of the outer face of the support layer.

The present invention further relates to a method for producing such a trim element.

### BACKGROUND

The invention applies e.g. to a trim element forming a door panel, a cover for a backrest or for seat cushion, a covering for a dashboard or for central console or other types of trim element.

In such a trim element, it is desirable to add other features for the passengers of the vehicle, on the outer surface of the trim element. The trim element can e.g. comprise one or a plurality of heated surfaces for improving the comfort of the vehicle.

The heating element arranged for heating a part of the outer surface, e.g. consisting of a resistive circuit, is integrated into the trim element, e.g. under a decorative layer so as to be invisible from the passenger compartment of the vehicle. For this purpose, the circuit is e.g. bonded to the support layer before applying the decorative layer to the support layer. However, such a method is complex, more particularly when a plurality of heating elements have to be placed in different zones of the support layer. Furthermore, the production of the trim element is expensive because the heating element has to be shaped, e.g. by cutting or printing, to form a resistive circuit.

### SUMMARY

One of the purposes of the invention is to overcome such drawbacks by proposing a trim element comprising at least one heated surface which would be simple to make, in a reliable and inexpensive way.

To this end, the invention relates to a trim element of the aforementioned type, in which the heating element comprises at least one discrete continuous carbon element, consisting of a carbon material extending continuously in an uninterrupted way from a first edge to a second edge, and a connecting device electrically connected with the carbon element, said connecting device being suitable for being electrically connected to a source of current.

By producing the heating element as a continuous element of discrete carbon material, the heating element can be produced in a very simple way and added to the trim element since it is not necessary to shape the heating element into a resistive circuit having a particular pattern. The production costs of the trim element are also reduced because the heating element can be simply applied to the support layer without requiring a prior shaping step of the heating element.

The trim element according to the invention can further comprise one or a plurality of the following features, taken individually or according to any technically conceivable combination:
the trim element further comprises a decorative layer extending over the outer face of the support layer, said decorative layer covering the heating element;
the heating element further comprises at least one protective layer extending between the carbon element and the decorative layer, said protective layer being made of a non-woven material;
the connecting device comprises a first electrode extending in the vicinity of the first edge of the carbon element and a second electrode extending in the vicinity of the second edge of the carbon element, said first electrode and said second electrode being electrically connected to the carbon element and being suitable for being connected to a source of current;
the first electrode and the second electrode extend between the carbon element and the support layer or are flush with the inner face of the carbon element;
the support element is made of a composite material comprising natural fibers in a polypropylene matrix;
the heating element comprises an inner face extending over the support layer and an outer face, opposite the inner face, the outer face of the heating element being flush with the face of the support layer over which the trim element extends.

According to another aspect, the invention relates to a method for producing a vehicle trim element, comprising the following steps:
providing a support layer,
placing a heating element on a part of an inner face or of an outer face of the support layer,
assembling the heating element and the support layer,
shaping the support layer along with the heating element,
connecting the heating element connecting device to a source of current.

The production method according to the invention can further have one or a plurality of the features below, taken individually or according to any technically conceivable combination:
the step of assembling the heating element with the support layer is carried out during or after a step of calibrating the support layer;
the connecting device is attached to at least one carbon element so as to form at least one heating element before placing said heating element on a part of the inner face or of the outer face of the support layer.

### BRIEF DESCRIPTION OF THE DRAWINGS

Other aspects and advantages of the invention will appear upon reading the following description, given only as an example, and producing reference to the enclosed drawings, wherein:

FIG. 1 is a simplified schematic frontal representation of a trim element according to the invention,

FIG. 2 is a schematic view of a part of the trim element shown in FIG. 1,

FIG. 3 is a section view along the axis III-III shown in FIG. 2,

FIG. 4 is a schematic view of an inner face of a heating element in a trim element according to one embodiment of the invention,

FIG. 5 is a schematic representation of an inner face of a heating element in a trim element according to another embodiment of the invention,

FIG. 6 is a schematic representation of an inner face of a heating element in a trim element according to another embodiment of the invention, and

FIG. 7 is a schematic section representation of a decorative layer for covering the heating element according to one embodiment of the invention.

### DETAILED DESCRIPTION

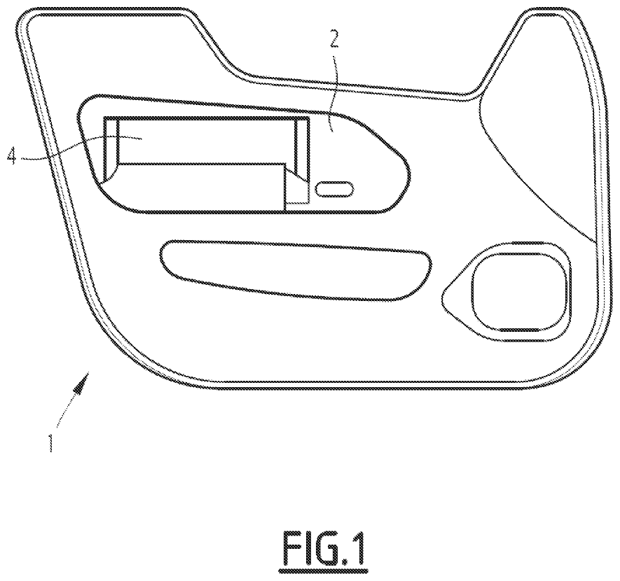

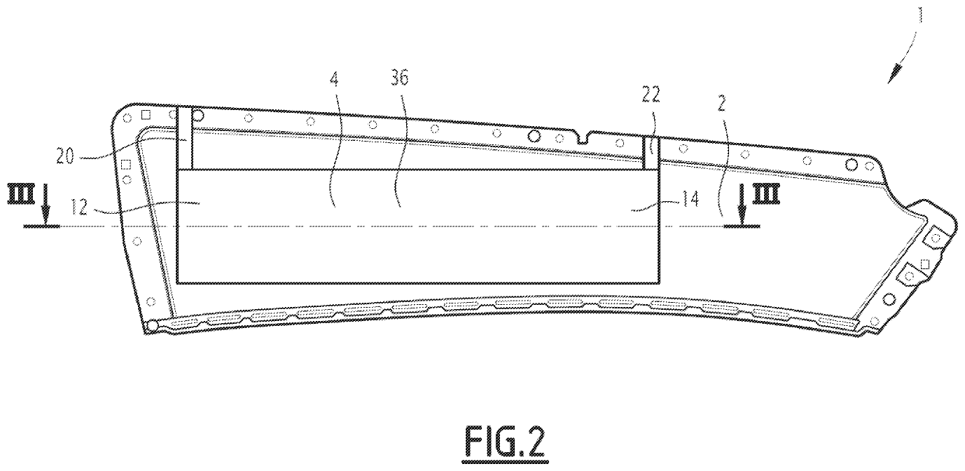

With reference to FIGS. 1 and 2, a trim element 1 for a vehicle comprising at least one support layer 2 and at least one heating element 4. Such a trim element is e.g. intended for forming a door panel, a cover for a backrest or for a seat cushion, a covering for a dashboard or for a central console or another type of trim element or part of a larger trim element, as shown in FIG. 2.

The support layer 2 is arranged so as to impart the shape thereof and part of the mechanical characteristics thereof to the trim element 1, more particularly the rigidity thereof. The support layer 2 is thus e.g. made of a substantially rigid material for a door panel, such as a plastic or composite material. According to one embodiment, the support layer 2 is made of a composite material comprising natural fibers in a polypropylene matrix, also known by the term NFPP (Natural Fiber Polypropylene). The natural fibers are chosen e.g. from flax, hemp, kenaf and/or wood. The support layer 2 is e.g. shaped by thermocompression molding in a pressing tool having the desired shape of the support layer 2, which substantially corresponds to the shape of the trim element 1, as will be subsequently described in greater detail. The support layer 2 thus has e.g. a three-dimensional shape with protruding zones. By way of example, the support layer 2 can comprise a protruding zone with respect to the rest of the support layer 2, so as to form an armrest.

In a variant, the support layer 2 is shaped by injecting a plastic material, such as polypropylene (PP), polycarbonate acrylonitrile butadiene styrene (PC ABS), into a molding cavity having the desired shape. According to another variant, the support layer is obtained by additive manufacturing with the desired shape.

The support layer 2 comprises an inner face 6, intended for extending towards the part of the vehicle wherein the trim element is to be installed, such as the door in the case of a door panel, and an outer face 8, opposite the inner face 6, and intended for being oriented towards the passenger compartment of the vehicle. The thickness of an element is defined as the distance between the inner face thereof and the outer face thereof. The face layer 2 has e.g. a thickness comprised between 1 mm and 3 mm.

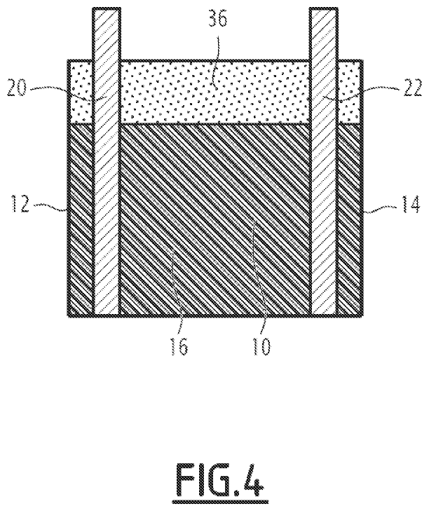

The heating element 4 comprises a discrete continuous carbon element 10 made of carbon material extending continuously in an uninterrupted way from a first edge 12 to a second edge 14. The term “discrete” means that the carbon element 10 does not extend over the entire surface of the support layer 2 as will be subsequently described. “Continuously and in an uninterrupted way” means that the carbon element 10 is made only of carbon material from the first edge 12 to the second edge 14 and that the entire surface of the carbon element is not interrupted by an opening separating the carbon element into two or more distinct parts from the first edge 12 to the second edge 14. In other terms, the carbon element 10 is in the form of a patch of carbon material applied to a part of the surface of the support layer 2. According to one embodiment, the carbon element 10 is solid from the first edge 12 to the second edge 14 and comprises no opening crossing through the thickness of the carbon element 10. The carbon element 10 has e.g. the shape of a rectangular parallelepiped, the first edge 12 and the second edge 14 forming two opposite sides of the rectangle and extending e.g. along the width of the rectangle, as shown in FIGS. 2 and 4. The carbon element comprises an inner face 16 and an outer face 18, each having a rectangular shape in the case of a patch having the shape of a rectangular parallelepiped. The carbon element 10 can have other shapes, e.g. another parallelepiped. The first edge 12 and the second edge 14 can extend, in a variant, along the length of the parallelepiped. The element carbon 10 has e.g. a thickness comprised between 20 μm and 200 μm.

The carbon material of the carbon element 10 comprises e.g. carbon fibers without sizing and/or recycled carbon fibers. More particularly, the carbon material comprises 95% or more by weight of carbon fibers, the remainder of the carbon material being e.g. PVA (polyvinyl alcohol) and/or glass fibers. Not sizing carbon fibers improves the electrical properties of the carbon element 10. The carbon element 10 thereby has better conductivity between the first edge 12 and the second edge 14 and improved continuity of the electrical contact after the shaping of the trim element, as will be subsequently described.

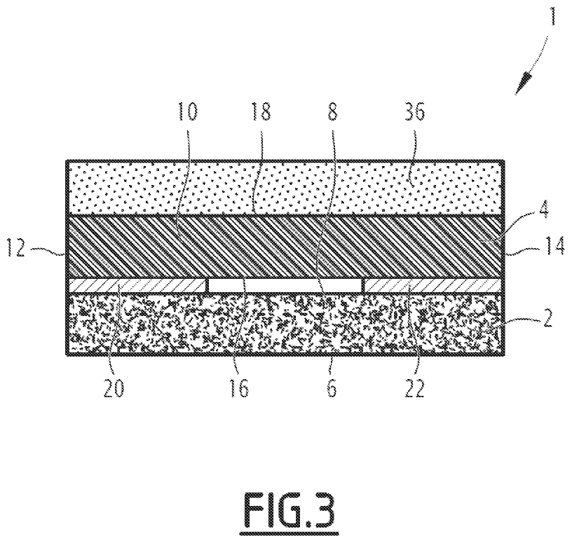

As described above, the carbon element 10 extends over a part of the support layer 2, more particularly over a part of the inner face 6 or of the outer face 8 of the support layer 2. When the carbon element 10 extends over an inner face 6, the outer face 18 of the carbon element 10 extends opposite the inner face 6 of the support layer 2. When the carbon element 10 extends over the outer face 8, the inner face 16 of the carbon element 10 extends opposite the outer face 8 of the support layer 2, as can be seen more particularly in FIG. 3. The description will now be given with reference to a heating element 4 extending over the outer face 8 of the support layer 2. A person skilled in the art would understand how the heating element 4 can be used on the inner face 6 of the support layer 2, on the basis of the present description.

The heating element 4 further comprises a connecting device electrically connected to the carbon element 10 and to a source of current, for supplying an electric current to the carbon element 10 so that the carbon element 10 produces heat by the Joule effect when the electric current flows through the carbon element 10. According to the embodiment shown in the figures, the connecting device comprises a first electrode 20 and a second electrode 22, each connected to the carbon element 10 so that the electric current flows from the first electrode 20 to the second electrode 22 through the carbon element 10. To this end, the first electrode 20 is connected to the carbon element 10 in the vicinity of the first edge 12 and the second electrode 22 is connected to the carbon element 10 in the vicinity of the second edge 14 so that the electric current flows through a majority of the carbon element from the first electrode 20 to the second electrode 22. Preferentially, the first electrode 20 extends along the first edge 12 and the second electrode 22 extends along the second edge 14, as shown in FIG. 4, so that the electric current flows through the entire surface of the carbon element 10 from the first edge 12 to the second edge 14.

Furthermore, as also shown in FIG. 4, the first electrode 20 and the second electrode 22 are extended outside the carbon element 10 so as to be connected to the current source (not shown), which is generally at a distance from the trim element 1. The source of current source consists e.g. of the electrical system of the vehicle wherein the trim element 1 is installed.

When the heating element 4 extends over the outer face 8 of the support layer 2, the first electrode 20 and the second electrode 22 extend e.g. on the inner face 16 of the carbon element 10 and are interposed between the carbon element 10 and the support layer 2 as shown in FIG. 3. In other terms, the support layer 2 also serves as a support for the electrodes which can be produced e.g. by printing on the support layer 2 or which can be assembled beforehand with the carbon element 10 before the heating element 4 is applied to the support layer 2 as will be subsequently described. The first electrode 20 and the second electrode 22 are e.g. made of copper, e.g. copper tracks extending over the support layer 2.

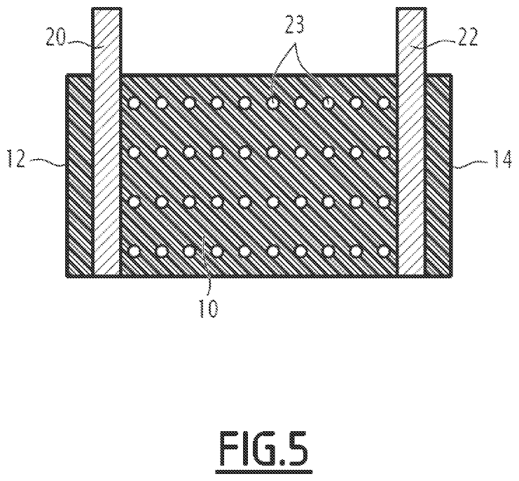

According to an embodiment shown in FIG. 5, the carbon element 10 further comprises a plurality of openings 23 extending through the thickness of the carbon element 10 and opening out into the inner face 16 and into the outer face 18 of the carbon element 10. Such openings are arranged so as not to interrupt the transmission of the current from the first edge 12 to the second edge 14. Such openings 23 reduce the quantity of carbon in the carbon element 10 in order to reduce the cost and the mass of the trim element 1.

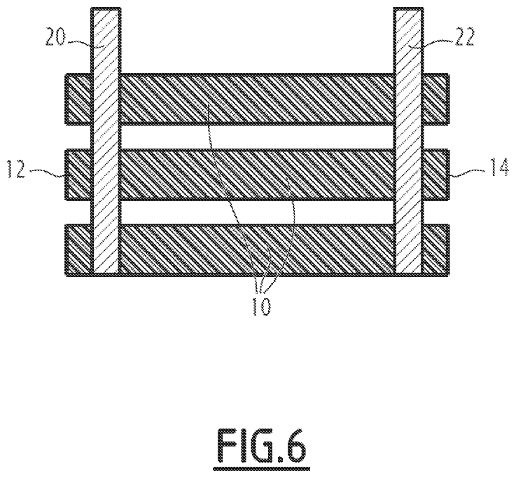

According to another embodiment shown in FIG. 6, a plurality of discrete carbon elements 10 are connected to the same connecting device, which means that the first electrode 20 and the second electrode are connected to a plurality of discrete carbon elements, so as to form a plurality of heating elements. With such an arrangement, a plurality of heating elements can be placed at different locations of the support layer 2 while feeding heating elements by means of a single connecting device connected to a single source of current.

It is understood that the embodiments described hereinabove can be combined, which means that at least one of the carbon elements 10 can comprise openings 23 when the connecting device is connected to a plurality of carbon elements 10.

Whereas the trim element 1 according to the invention can be used as such, i.e. only with the support layer 2 and the heating element(s) 4 comprising only the carbon element 10 and the connecting device, the trim element 1 preferentially further comprises a decorative layer 24 extending on the side of the outer face 8 of the support layer 2 over at least a part of the outer face 8. More particularly, the decorative layer 24 comprises an inner face 26 turned towards the outer face 8 of the support layer 2 and an outer face 28 turned towards the outside of the trim element 1 and forming a visible part of the trim element 1.

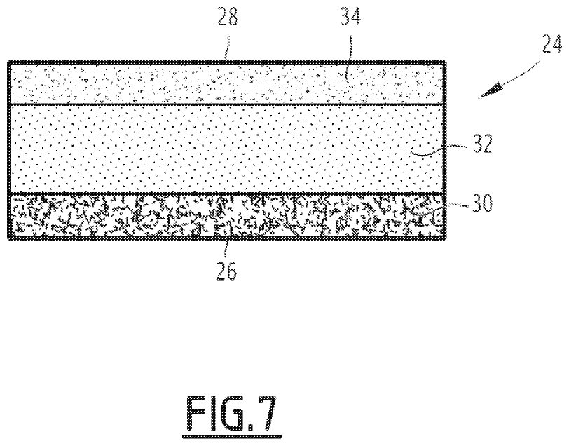

The decorative layer 24 shown in FIG. 7, is arranged to impart the finish and the feel thereof to the trim element 1. The decorative layer 24 is hence e.g. made of a flexible or rigid material having a particular finish and/or feel which is desired to impart to the trim element 1. According to the embodiment shown in FIG. 7, the decorative layer comprises a plurality layer of different materials, such as, from the inner face 26 to the outer face 28: a layer of adhesive material 30, a layer of foam 32 and a finish layer 34.

The layer of adhesive material is arranged so that the decorative layer 24 can be fastened to the support layer 2, and possibly to the heating element 4 as will be subsequently described, when the inner face 26 of the decorative layer 24 is applied to the outer face 8 of the support layer 2. The adhesive material is e.g. a thermos adhesive which can be activated or an aqueous adhesive e.g. applied to a scrim fastened to the foam layer 32.

The foam layer 32 imparts a feeling of soft touch on the outer surface of the trim element 1 when a user touches the trim element 1. The foam is e.g. a polyethylene (PE) foam or a polyurethane (PU) foam.

The finish layer 34 is arranged to impart the finish thereof to the trim element 1 and forms the outer surface of the trim element. To this end, the finish 34 consists e.g. of a skin of synthetic material, such as a skin of thermoplastic polyolefin (TPO) or a skin of polyvinyl chloride (PVC). In a variant, other materials could be used for forming the finish layer 34, such as a textile material, a woody material, leather, imitation leather, etc.

In a variant, the decorative layer 24 does not comprise a foam layer and comprises only the layer of adhesive material 30 and the finish layer 34.

The thickness of the decorative layer 24 is comprised e.g. between 0.4 mm and 5 mm, the foam layer 32 having e.g. a thickness comprised between 1.5 mm and 3.5 mm.

In all cases, when the heating element 4 extends between the support layer 2 and the decorative layer 24, the heating element 4 further comprises a protective layer 36 interposed between the outer face 18 of the carbon element 10 and the inner face 26 of the decorative layer 24. The protective layer 36 is arranged for preventing the heat emitted by the heating element 4 from damaging the decorative layer 24. The protective layer 36 is e.g. made of a non-woven material. The non-woven material comprises e.g. polypropylene (PP) fibers or a mixture of polypropylene and polyethylene terephthalate (PET) depending on the nature of the adhesive layer 30 and/or of the foam layer 32 of the decorative layer 24 applied over the heating element 4. As shown in FIG. 4, the protective layer 36 can have a surface area greater than the surface area of the carbon element 10 so as to fully cover the carbon element 10 and to improve the protection provided by the protective layer 36.

It will be noted that, according to one embodiment, another protective layer can be provided between the carbon element 10 and the support layer 2, in order to protect the support layer 2 from the heat generated by the heating element 4. In such case, the connecting device extends between the carbon element 10 and the additional protective layer.

The trim element 1 described can be used for heating a part of the outer surface of the trim element in a simple and economical way, the heating element 4 having a particularly simple structure due to the use of a continuous and discrete carbon element 10 for generating the heat. It is understood that a plurality of heating elements 4 can be provided for forming a plurality of corresponding heated zones on the outer surface of the trim element.

Furthermore, the trim element 1 according to the invention can be produced in a simple, rapid and economical way, as will now be described.

The method for producing the trim element 1 described hereinabove comprises the following steps:
providing a support layer 2,
placing a heating element 4 on a part of an inner face 6 or of the outer face 8 of the support 2 layer,
assembling the heating element 4 and the support layer 2,
shaping the support layer 2 along with the heating element 4,
connecting the heating element connecting device 4 to a source of current.

Before placing the heating element 4 on a part of a face of the support layer 2, the carbon element is assembled with the connecting device, i.e. the first and second electrodes 20, 22 are electrically connected with the carbon element. A protective layer 36 can also be assembled with the carbon element 10 during said step. The assembly is then assembled with the support layer 2. When the same connecting device is connected to a plurality of discrete carbon elements 10, all the carbon elements 10 are connected to the connecting device before assembling the heating elements 4 on a part of the face of the support layer 2.

The heating element 4 can be assembled with the support layer 2, e.g. during a step of sizing the support layer 2. The sizing step is arranged for imparting the shape, the mechanical characteristics and dimensions that the support layer should have in the finished trim element 1, to the support layer. When the heating element 4 is assembled with the support layer 2 during the sizing step, the heating element 4 is placed on the support layer 2 and said assembly is placed in a sizing tool wherein the assembly is pressed. Therefore, the heating element 4 is pressed onto the support layer 2, which makes the heating element 4 flush with the outer face 8 of the support layer 2, when the heating element 4 is placed on the outer face 8 of the support layer 2. The first and second electrodes 20, 22 are also flush with the inner face 16 of the carbon element 10 when the heating element 4 is assembled with the support layer 2 during the sizing step. By flush, it is understood that the outer face of the heating element 4, corresponding e.g. with the outer face of the protective layer 36, is continuous with the outer face 8 of the support layer 2, the heating element 4 extending in the thickness of the support layer 2. Therefore, when the heating element 4 is assembled with the support layer 2 during the sizing step, the heating element 4 can be integrated into the support layer 2 in a non-protruding way, which improves the finish of the trim element 1 and facilitates the assembly of the decorative layer 24.

In a variant, the heating element 4 can be assembled with the support layer 2 after the sizing step. In such case, the heating element 4 is e.g. laminated with the support layer 2 after the sizing step in the laminating tool used for applying the decorative layer 24 to the support layer 2. Therefore, the heating element 4 can be assembled with the support layer 2 at the same time as the decorative layer 24.

After said assembly, the trim element can be shaped into a three-dimensional shape by placing the assembly in a forming tool.

The method described hereinabove can be carried out in a small number of steps and makes it possible to obtain a finished trim element 1 at the outlet of the forming tool. The connection of the connecting device to a source of current can occur when the trim element 1 is mounted in a vehicle, e.g. by connecting the connecting device to the electrical system of the vehicle. The connection can be obtained by clipping connection elements provided at the free end of the first and second electrodes 20, 22 to a corresponding connector provided in the vehicle. In a variant, the free ends of the electrodes can be welded to corresponding cables in the vehicle or connected to said cables by riveting or crimping.

1. A vehicle trim element comprising at least one support layer having an inner face and an outer face, and at least one heating element extending over a part of the inner face or over a part of the outer face of the support layer, wherein the heating element comprises at least one discrete continuous carbon element that comprises a carbon material extending continuously in an uninterrupted way from a first edge to a second edge, and a connecting device electrically connected with the carbon element, said connecting device being suitable for being electrically connected to a source of current.

2. The trim element according to claim 1, further comprising a decorative layer extending over the outer face of the support layer, said decorative layer covering the heating element.

3. The trim element according to claim 2, wherein the heating element further comprises at least one protective layer extending between the carbon element and the decorative layer, said protective layer being made of a non-woven material.

4. The trim element according to claim 1, wherein the connecting device comprises a first electrode extending in the vicinity of the first edge of the carbon element and a second electrode extending in the vicinity of the second edge of the carbon element, said first electrode and said second electrode being electrically connected to the carbon element and being suitable for being connected to the source of current.

5. The trim element according to claim 4, wherein the first electrode and the second electrode extend between the carbon element and the support layer or are flush with the inner face of the carbon element.

6. The trim element according to claim 1, wherein the at least one support layer is made of a composite material comprising natural fibers in a polypropylene matrix.

7. The trim element according to claim 1, wherein the heating element comprises an inner face extending over the support layer and an outer face opposite the inner face, the outer face of the heating element being flush with the face of the support layer over which the trim element extends.

8. A method for producing a trim element according to claim 1, comprising the following steps:
providing the support layer,
placing the heating element on part of the inner face or of the outer face of the support layer,
assembling the heating element and the support layer, and
shaping the support layer along with the heating element.

9. The method according to claim 8, wherein the step of assembling the heating element to the support layer is carried out during or after a step of sizing the support layer.

10. The method according to claim 8, wherein the connecting device is attached to the at least one carbon element so as to form the at least one heating element before placing said heating element on the part of the inner face or of the outer face of the support layer.

11. The method according to claim 8, further comprising connecting the connecting device of the heating element to a source of current.
